(19) United States
(12) Patent Application Publication
(10) Pub. No.: US 2004/0221151 A1
(43) Pub. Date: Nov. 4, 2004

(54) Information processing system including communication-enabled information processing device equipped with no user interface and a method of control thereof

(75) Inventor: Tsunehiro Kajita, Sagamihara-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/802,179

(22) Filed: Mar. 17, 2004

(30) Foreign Application Priority Data
Mar. 18, 2003 (JP) 2003-073171

(51) Int. Cl. G06F 9/00; G06F 15/177; G06F 3/00; G06F 9/445

(52) U.S. Cl. 713/2; 713/100; 709/222; 710/1; 710/10; 717/178

(57) ABSTRACT

A system in which a plurality of information processing devices connected to each other via a communication network share an input/output device even during booting of OSs of the information processing devices. An information processing device (1) equipped with user interfaces (15) and (16) has a driver program storage section (14) for user input/output devices (6) and (7), and a program storage section (13) for emulation of information processing devices (3) to (5) through the user interfaces (15) and (16). The information processing device (3) equipped with no user interface has an NC check program (331), an address acquisition program (332) for acquiring a second address number of the information processing device (3), and a program (333) for establishing a link with the information processing device (1), which are stored in a BIOS storage section (33). The information processing device (3) also has a program (341) for inheriting the second address number, and a program (342) for inheriting the link with the information processing device (1), which are stored in an OS storage section (34).

### BACKGROUND DESCRIPTION OF THE INVENTION

1. Field of the Invention

The present invention relates to an information processing system in which a first communication-enabled information processing device equipped with a user interface and a second communication-enabled information processing device equipped with no user interface are connected via a communication network, and to a method of controlling the second communication-enabled information processing device by using the user interface of the first communication-enabled information processing device in the information processing system. More particularly, the present invention relates to a method of control at the time of starting up a power supply of the second communication-enabled information processing device.

2. Background Art

Japanese Published Unexamined Patent Application (PUPA) No. 11-126134 discloses a method of enabling a plurality of information processing devices to share an input device such as a keyboard or a mouse, a method is known which enables a plurality of information processing devices to be operated with one input device in such a manner that, for example, each of the plurality of information processing devices is provided with an infrared communication function and the input device is also provided with an infrared communication function and further with, as its internal functions, an ID changing function and a temporary data storage function for infrared communication.

Japanese Published Unexamined Patent Application (PUPA) No. 2001-331259 discloses a method of enabling a plurality of information processing devices connected to each other via a communication network to share an input device such as a keyboard or a mouse, a method is known which enables a plurality of information processing devices connected to each other via a communication network to be operated with one set of input means in such a manner that each information processing device uses a communication function with other information processing devices provided in its operating system (OS) to have a step of selecting itself or one of the other information processing devices as a target to be operated, and a step of converting input contents of its input device into key codes for one of the other information processing devices and transmitting the key codes when the one of the other information processing devices is selected.

The above prior art presents several problems that are solved by the present invention. Regarding the method set forth in PUPA No. 2001-331259 the problem is that there is a need to provide each of the information processing devices and input device with an infrared communication means or the like, which is a special piece of equipment not provided in ordinary cases, and the method cannot be carried out in the conventional information processing devices heretofore used. Regarding PUPA No. 2001-331259 it is thought that the method can be carried out by only adding a program to conventional information processing devices connected to a communication network. However, since a communication function of an OS is used, no input means can be shared before one of the information processing devices is normally booted up and before a communication link to the other information processing devices is established. Therefore, there is a problem that when a trouble occurs in the course of booting the OS of one information processing device by turning on the power supply of that information processing device, the information processing device cannot be operated by an input device of other information processing devices.

In recent years, in particular, there have been cases where, for the purpose of storing information for example, a plurality of communication-enabled information processing devices each having only an ordinary storage capacity are used after systematization by connecting to a communication network instead of a single mass storage. In many of such cases, input and output devices of the communication-enabled information processing devices other than the one for control and interfaces for the input and output devices are removed to reduce the cost and housing size. When a trouble occurs in one of communication-enabled information processing devices not having such user interfaces in the course of booting the OS by turning on the power, it outputs no signal to an output device, e.g., a video output device or the like of the communication-enabled information processing device for control, and cannot be operated by an input device such as a keyboard or a mouse. In such a situation, details of the trouble cannot be analyzed and no measures can be taken against the trouble.

### SUMMARY OF THE INVENTION

The present invention aims to solve the above-described problems. An object of the present invention is to provide a system and a method which enable, without using any special piece of equipment not used in ordinary cases, input and output devices to be shared by a plurality of information processing devices connected to each other via a communication network even before an OS is normally booted by power for an information processing devices and a communication link with the other information processing devices is established.

To achieve the above-described object, the present invention provides an information processing system including a communication-enabled information processing device equipped with no user interface, in which at least one first communication-enabled information processing device equipped with a user interface and at least one second communication-enabled information processing device equipped with no user interface are connected to each other through a communication network, wherein the first communication-enabled information processing device has at least a storage section storing a driver program for a user input/output device, and a storage section storing a program for emulating the second communication-enabled information processing device through the user interface, the user input/output device being connected to the first communication-enabled information processing device, and the second communication-enabled information processing device has a BIOS (Basic Input Output System) storage section which stores at least a check program for checking the operation of a communication control section, an address acquisition program for acquiring a second address number of the second communication-enabled information processing device in the communication network, and a program for establishing a link with the first communication-enabled information processing device, and an OS storage section which stores at least a program for inheriting the second address number and changing the second address number if needed, and a program for inheriting the link with the first communication-enabled information processing device.

The present invention also provides a method for controlling an information processing system including a communication-enabled information processing device equipped with no user interface, in which at least one first communication-enabled information processing device equipped with a user interface and at least one second communication-enabled information processing device equipped with no user interface are connected to each other through a communication network, wherein in the second communication-enabled information processing device connected to the first communication-enabled information processing device in operation, when a power supply is turned on, a BIOS operation stage has the steps of (1) starting a POST, (2) checking the operation of a communication control section, (3) acquiring a second address number of the second communication-enabled information processing device in the communication network, (4) establishing a link between the first and second communication-enabled information processing devices, (5) sending presentation data to the first communication-enabled information processing device, (6) executing contents received from the first communication-enabled information processing device, (7) terminating the POST, and (8) booting an OS, and an OS operation stage has the steps of (9) inheriting the link established in the BIOS operation stage and the second address number, (10) transmitting presentation data to the first communication-enabled information processing device, and (11) executing contents received from the first communication-enabled information processing device.

### BRIEF DESCRIPTION OF DRAWINGS

FIG. 1 is a block diagram showing the configuration of an information processing system of a first embodiment of the present invention including a communication-enabled information processing device equipped with no user interface;

FIG. 2 is a diagram showing examples of various programs stored in an emulation program storage section shown in FIG. 1;

FIG. 3 is diagram showing examples of various programs stored in a BIOS storage section shown in FIG. 1;

FIG. 4 is diagram showing examples of various programs stored in an OS storage section shown in FIG. 1;

FIG. 5 is a flowchart showing the outline of the operation at the time of power on for the information processing device in FIG. 1;

FIG. 6 is a flowchart showing further details of the operation with respect to setting of the communication control section shown in FIG. 5 at the time of power on for the information processing device;

FIG. 7 is a flowchart showing further details of the operation with respect to IP address acquisition and storage for a POST execution machine shown in FIG. 5 at the time of power on for the information processing device;

FIG. 8 is a flowchart (1/2) showing further details of the operation with respect to link establishment between a KVM machine and a POST execution machine shown in FIG. 5 at the time of power on for the information processing device;

FIG. 9 is a flowchart (2/2) showing further details of the operation with respect to link establishment between the KVM machine and the POST execution machine shown in FIG. 5 at the time of power on for the information processing device;

FIG. 10 is a flowchart showing further details of the operation with respect to communication after link establishment during BIOS operation shown in FIG. 5 at the time of power on for the information processing device;

FIG. 11 is a flowchart showing the operation in the case of refreshing the display screen of the KVM machine in communication after link establishment during BIOS operation shown in FIG. 5 at the time of power on for information processing device, or in communication after link establishment during OS operation; and

FIG. 12 is a flow chart showing the operation in the case of changing the IP address number of the KVM machine in communication after link establishment during BIOS operation shown in FIG. 5 at the time of power on for the information processing device, or in communication after link establishment during OS operation.

### DESCRIPTION OF AN EMBODIMENT

The present invention will be described on the basis of an embodiment with reference to the drawings.

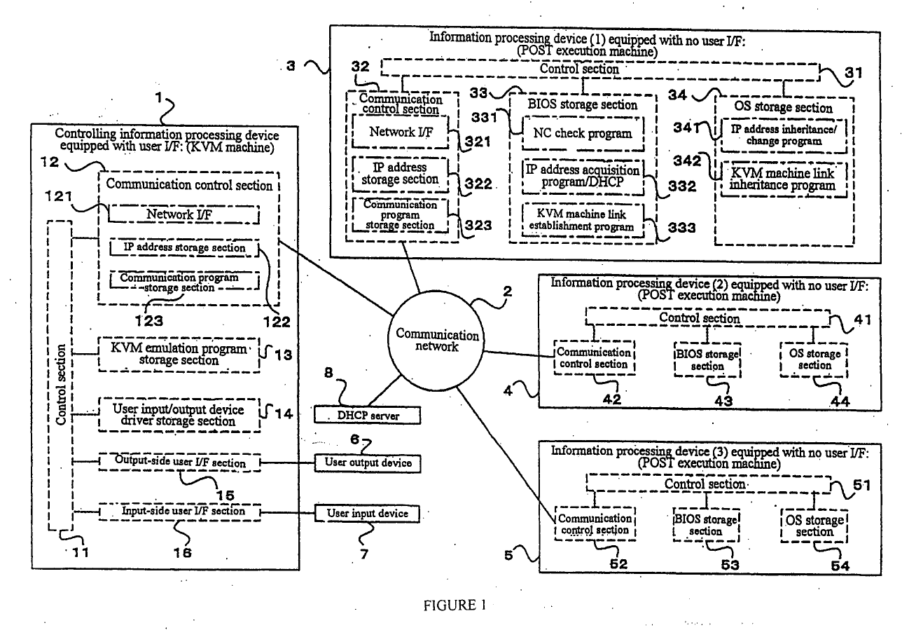

FIG. 1 is a block diagram showing the configuration of an information processing system of a first embodiment of the present invention including a communication-enabled information processing device equipped with no user interface.

In FIG. 1, details of the configuration specific to this embodiment are mainly shown and, in particular, details relating to boot-up when an power switch not shown in the figure is turned on in an information processing devices 3 to 5 while an information processing device 1 is operating are mainly shown. On the other hand, known details of the configuration relating to the operation after completion of OS booting are omitted.

In the information processing system shown in FIG. 1, the information processing device 1 (first communication-enabled information processing device) equipped with user interfaces including a keyboard (K), a video image display device (V) such as a liquid crystal panel or a cathode ray tube, and a mouse (M) (also referred to as KVM) and information processing devices 3 to 5 (second communication-enabled information processing devices) equipped with no user interface are connected to each other by a communication network 2. A user output device 6 is, for example, a video image display device (V) such as a liquid crystal panel or a cathode ray tube, or an audio output device such as a speaker. A user input device 7 is, for example, a keyboard (K), which is a character input device on which character input keys and numeral keys are disposed, a mouse (M), which is a pointing device for designating any point on a screen, a digitizer, a tablet, or the like. A DHCP (Dynamic Host Configuration Protocol) server 8 is a server which sets and assigns an IP (Internet Protocol) address number in response to a request from a unit which will newly participate in communication on the communication network. DHCP is a protocol for automatically setting IP address numbers on a local area network (LAN). Each of the information processing devices used in this embodiment is of a communication-enabled type capable of transmitting and receiving data or the like in communication with any of the other information processing devices via the communication network 2.

In the information processing device 1, a control section 11 having a computation means such as a microprocessor and a storage means such as a RAM controls the operation of the entire information processing device 1. A communication control section 12 controls transmission and reception of data via the communication network 2, conversion of data, etc., under the control of the control section 11. An emulation program storage section 13 stores a program for emulating the second information processing devices 3 to 5 by using the user output device 6 and the user input device 7 described below. A user input/output device driver storage section 14 stores driver programs for the user output device 6 and the user input device 7. An output-side user interface (I/F) section 15 converts an internal signal to output the user output device 6 a signal for display of an image on the video image display device (V) or the like, an audio signal or the like. An input-side user interface (I/F) section 16 converts an input signal from the user input device 7, which is a keyboard (K), a mouse (M) or the like, into an internal signal and outputs the internal signal.

In the communication control section 12, a network interface 121 converts the format of a signal processible in the information processing device 1 into a signal format transmittable by the communication network 2 and, conversely, converts the format of a signal received from the communication network 2 into a signal in a format processible in the information processing device 1. An IP address storage section 122 stores IP address numbers which are numbers designating the locations of specific devices or ports in the communication network 2 in a case where the communication network 2 is, for example, a local area network (LAN). A communication program storage section 123 stores details of a request or a notice at the time of data transmission/reception, a communication procedure, etc.

In the information processing device 3, a control section 31 having a computation means such as a microprocessor and a storage means such as a RAM controls the entire information processing device 3. A communication control section 32 controls transmission and reception of data via the communication network 2, conversion of data, etc., under the control of the control section 31. A BIOS storage section 33 stores BIOS codes providing low-level hardware support to an OS. A BIOS is first executed when the information processing device 3 is powered on. Ordinarily, BIOS codes are supplied to the information processing device by writing in a semiconductor device such as an IC. An OS storage section 34 stores the OS, which is a control program for the information processing device 3.

In the communication control section 32, a network interface 321 converts the format of a signal processible in the information processing device 3 into a signal format transmittable by the communication network 2 and, conversely, converts the format of a signal received from the communication network 2 into a signal in a format processible in the information processing device 3. An IP address storage section 322 stores IP address numbers which are numbers designating the locations of specific devices or ports in the communication network 2 in a case where the communication network 2 is, for example, a LAN. A communication program storage section 323 stores details of a request or a notice at the time of data transmission/reception, a communication procedure, etc.

In the BIOS storage section 33, programs described below, for example, are stored. An NC (Network Controller) check program 331 checks the operation of the communication control section at least with respect to an NIC (Network Interface Controller) or the like. An address acquisition program 332 obtains an address number (second address number) of the information processing device 3 in the communication network 2. A KVM machine link establishment program 333 establishes a link to the information processing device 1.

In the OS storage section 34, programs described below, for example, are stored. An IP address inheritance/change program 341 inherits a second address number obtained by the address acquisition program 332 stored in the BIOS storage section 33, and changes the second address number as required. A KVM machine link inheritance program 342 inherits a link to the information processing device 1 established by the KVM machine link establishment program 333.

The information processing devices 4 and 5 have the same configuration as that of the information processing device 3. The information processing device 4 is provided with a control section 41, a communication control section 42, a BIOS storage section 43 and an OS storage section 44. Similarly, the information processing device 5 is provided with a control section 51, a communication control section 52, a BIOS storage section 53 and an OS storage section 54. A case of establishment of a link between the information processing device 1 and the information processing device 3 will be described below. However, the same description applies to establishment of a link between the information processing device 1 and the information processing device 4 and to establishment of a link between the information processing device 1 and the information processing device 5.

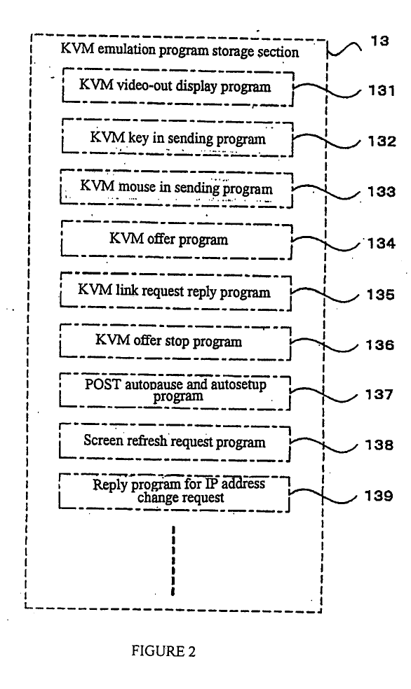

FIG. 2 shows examples of various programs stored in the emulation program storage section 13 shown in FIG. 1.

A KVM video-out display program 131 in the emulation program storage section 13 is a program for displaying presentation data in a text format or a graphic format on the display of the user output device 6 or the like in the information processing device 1 when the presentation data is sent out from the information processing device 3 during BIOS operation or OS operation.

A KVM key in transmitting program 132 is a program for transmitting details of input made through a keyboard or the like of the user input device 7 in the information processing device 1 to the information processing device 3 when the input is made during BIOS operation or OS operation of the information processing device 3.

A KVM mouse in transmitting program 133 is a program for transmitting details of input made through a mouse or the like of the user input device 7 in the information processing device 1 to the information processing device 3 when the input is made during BIOS operation or OS operation of the information processing device 3.

A KVM offer program 134 is a program for sending out to the information processing device 3 a message for offering a link when the information processing device 1 receives a message sent out from the information processing device 3 during BIOS operation for locating the information processing device 1 as a link destination.

A KVM link request reply program 135 is a program for establishing a link and sending a corresponding notice to the information processing device 3 when the information processing device 1 receives a link request message sent out from the information processing device 3 during BIOS operation.

A KVM offer stop program 136 is a program for stopping offering of a link by the KVM offer program 134 when the information processing device 1 receives a request to stop offering of the link. The KVM offer program 134 itself may switch offering on and off. In such a case, the KVM offer stop program 136 is unnecessary.

A POST autopause and autosetup program 137 is a program for automatically sending out a key in of a pause key or a PF2 key to the information processing device 3 in a situation where the autopause or autosetup function is enabled in the information processing device 1 when a POST is being executed during BIOS operation in the information processing device 3.

A screen refresh request program 138 is a program for requesting the information processing device 3 to transmit data corresponding to one frame for refreshment of the display screen of the information processing device 1.

A program 139 for replying to an IP address change request is a program for notifying the information processing device 3 of a changed first address number and reestablishing a link at a request from the information processing device 3 when the information processing device 1 receives from the information processing device 3 a request message for changing the current IP address number (first address number) of the information processing device 1.

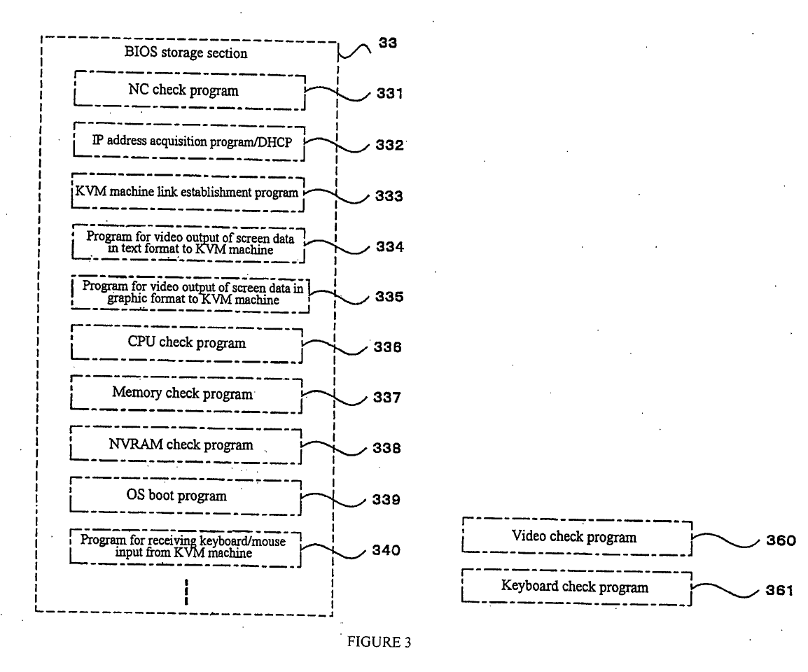

FIG. 3 shows examples of various programs stored in the BIOS storage section 33 shown in FIG. 1.

The NC check program 331 in the BIOS storage section 33 is a program for checking the state of connection of the communication control section 32 to the communication network 2 and the operation of the communication control section 32.

The IP address acquisition program/DHCP 332 is a program for automatically obtaining an IP address number of the information processing device 3 by the DHCP from the DHCP server 8.

The KVM machine link establishment program 333 is a program for establishing a link to the information processing device 1 by using an obtained IP address number or the like for the information processing device 3.

A program 334 for outputting screen data in a text format to the KVM machine is a program for transmitting presentation data in a text format from the information processing device 3 to the information processing device 1.

A program 335 for outputting screen data in a graphic format to the KVM machine is a program for transmitting presentation data in a graphic format from the information processing device 3 to the information processing device 1.

A CPU check program 336 is a program for checking the operation of the control section 31.

A memory check program 337 is a program for checking the capacity and operation of a memory such as a RAM by, for example, dividing the memory into a memory having a capacity of 1 MB or less and a memory having a capacity exceeding 1 MB.

An NVRAM check program 338 is a program for checking the existence/nonexistence of an IP address number (second address number) of the information processing device 3 stored in an NVRAM which is a nonvolatile storage means formed by a CMOS or the like, and for checking the existence/nonexistence of an IP address number (first address number) of the information processing device 1 if necessary.

An OS boot program 339 is a program for booting the OS from the OS storage section 34 or the like subsequently to the completion of the POST by the BIOS.

A program 340 for receiving a keyboard/mouse input from the KVM machine is a program for receiving a keyboard/mouse input from the information processing device 1 having the user input device 7.

A video check program 360 is a program for checking the connection and operation of a display device such as an ordinary liquid crystal display or a cathode ray tube display in the information processing device having this kind of display device. In this embodiment, however, this program is deleted from the information processing device or kept in a suspended state to inhibit the operation of the program.

A keyboard check program 361 is a program for checking the connection and operation of an input device such as an ordinary keyboard or a mouse in the information processing device having this kind of input device. In this embodiment, however, this program is deleted from the information processing device or kept in a suspended state to inhibit the operation of the program.

The BIOS storage section 33 is further provided with other programs, including a program for checking plug and play of a PCI bus, a program for checking details of BIOS codes by checksum, an IDE device check program, a USB check program, a power management check program, and a setup branch program.

The BIOS storage section 33 of this embodiment differs from the conventional BIOS storage section mainly in that a link can be established by the NC check program 331, the IP address acquisition program/DHCP 332 and the KVM machine link establishment program 333 through the communication between the information processing device 3 and the information processing device 1 at the BIOS operating stage.

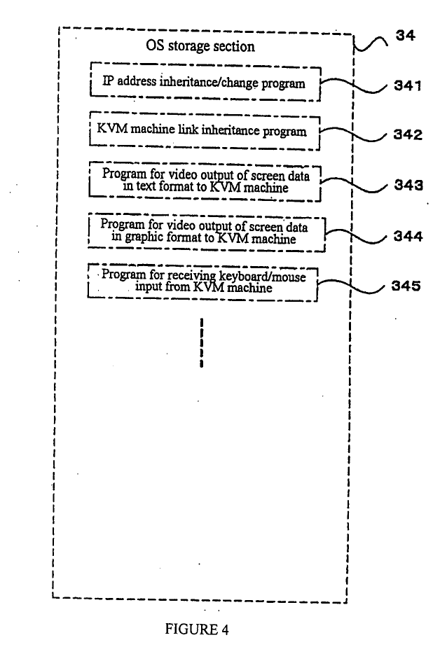

FIG. 4 shows examples of various programs stored in the OS storage section 34 shown in FIG. 1.

The IP address inheritance/change program 341 in the OS storage section 34 is a program for inheriting a second address number obtained by the IP address acquisition program/DHCP 332 and other address numbers (including a first address number) in BIOS operation and for changing the second address number as required.

The KVM machine link inheritance program 342 is a program for inheriting a link between the information processing device 3 and the information processing device 1 established by the KVM machine link establishment program 333 in BIOS operation.

A program 343 for outputting screen data in a text format to the KVM machine is a program for transmitting presentation data in a text format from the information processing device 3 to the information processing device 1. This program is similar to the program 334 for outputting screen data in a text format to the KVM machine during BIOS operation. The difference between these programs is whether the operation is on the BIOS or on the OS.

A program 344 for outputting screen data in a graphic format to the KVM machine is a program for transmitting presentation data in a graphic format from the information processing device 3 to the information processing device 1. This program is also similar to the program 335 for outputting screen data in a graphic format to the KVM machine during BIOS operation. The difference between these programs is whether the operation is on the BIOS or on the OS.

A program 345 for receiving a keyboard/mouse input from the KVM machine is a program for receiving a keyboard/mouse input from the information processing device 1 having the user input device 7. This program is also similar to the program 340 for receiving a keyboard/mouse input from the KVM machine during BIOS operation. The difference between these programs is whether the operation is on the BIOS or on the OS.

Many other programs are also provided in the OS storage section 34 in this embodiment. However, the other programs will not be described since they are not specific to the present invention.

The operation of this embodiment will now be described.

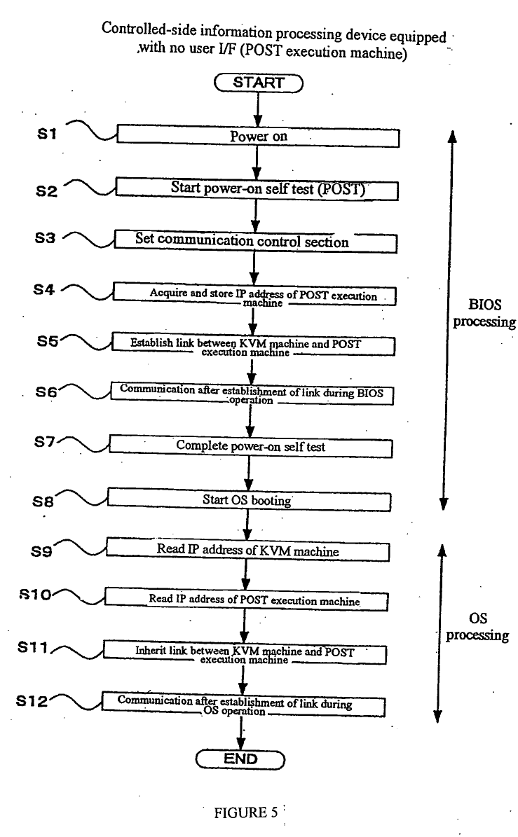

FIG. 5 is a flowchart showing the outline of the operation of the information processing device 3 shown in FIG. 1 at the time of power on of the information processing device 3.

The flowchart of FIG. 5 outlines the flow of operation in a situation where the information processing device 1 (KVM machine) is operating and the information processing device 3 (POST execution machine) physically connected to the information processing device 1 by the communication network 2 which is a LAN or the like is powered on.

In the information processing device 3, when the power switch (not shown) is turned on (S1), the BIOS code is read out from an IC chip or the like so that, the BIOS operation is initiated to start a power on self test (POST) (S2).

In the POST operation of the information processing device 3 of this embodiment, setting and operation checking for the communication control section are first performed (S3), an IP address number (second address number) of the information processing device 3 in the communication network 2 is obtained and stored (S4), and a link is established between the information processing device 3 and the information processing device 1 (S5).

When a link is established in the BIOS operating state, the information processing device 3 performs communication with information processing device 1 by receiving a code of a key input, a mouse input or the like from the information processing device 1 while transmitting presentation data to the information processing device 1 in parallel with the POST processing. At this time, necessary processing is performed on the basis of a code or the like received from the information processing device 1 (S6). For instance, in a case where presentation data on the operating state of the information processing device 3 is transmitted to the information processing device 1 and a code of a key input for instruction to change the operating state is received by the information processing device 3, processing for changing the operating state according to the key input code is executed in the information processing device 3.

In the information processing device 3, when the POST processing in the BIOS operating state is completed (S7), booting of the OS is started (S8). When booting of the OS is completed, a transition to the OS operating state is made.

At an OS operating stage in the information processing device 3, the IP address number (first address number) of the information processing device 1 in the communication network 2 obtained at the BIOS operating stage is read out from the IP address storage section 322 (S9), and the IP address number (second address number) of the information processing device 3 is also read out from the IP address storage section 322 (S10).

In the information processing device 3, the link established at the BIOS operating stage is inherited by using the first and second address numbers read out (S11). When the link is inherited in the OS operating state, the information processing device 3 performs communication with the information processing device 1 by receiving a code of a key input, a mouse input or the like from the information processing device 1 while transmitting presentation data to the information processing device 1. At this time, necessary processing is performed on the basis of a code or the like received from the information processing device 1 (S12).

Thus, in this embodiment, the information processing device 3 can establish a link at the initial stage of POST processing in the BIOS operating state and can therefore transmit presentation data to the information processing device 1 and receive a code of a key input, a mouse input or the like from the information processing device 1 even in the BIOS operating state. Further, the established linked state can be inherited in the OS operating state. Therefore the occurrence of failure to cope with a trouble during the time period from turning on of the power switch to the completion of booting of the OS is reduced in comparison with the conventional art.

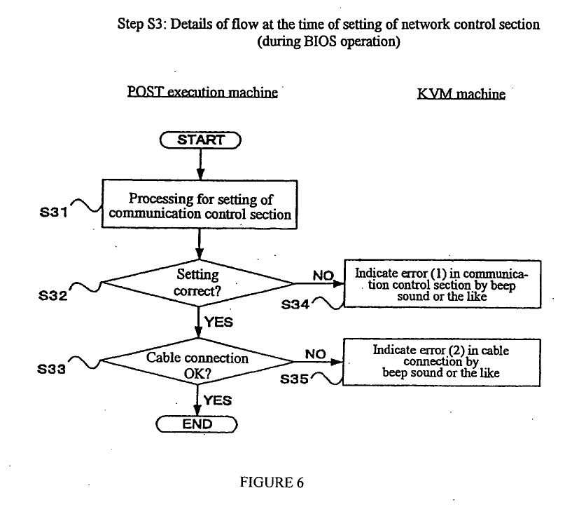

FIG. 6 is a flowchart showing further details of the operation in “S3: Set communication control section” shown in FIG. 5 at the time of power on for the information processing device 3.

The control section 31 of the information processing device 3 first checks the setting of the communication control section 32 and makes a determination as to whether the setting is correct (S32). If the setting is not correct (S32: NO), the control section 31 indicates that there is an error in the setting by combination with a buzzer (beep) sound, blinking of an LED, or the like (S34).

If the setting is correct (S32: YES), the control section 31 of the information processing device 3 checks whether the communication cable is correctly connected (S33). If the connection cable is not correctly connected (S33: NO), the control section 31 indicates that there is an error in the connection of the communication cable setting by combination with a buzzer (beep) sound, blinking of an LED, or the like (S35). If the connection cable is correctly connected (S33: YES), processing in “S3: Set communication control section” ends.

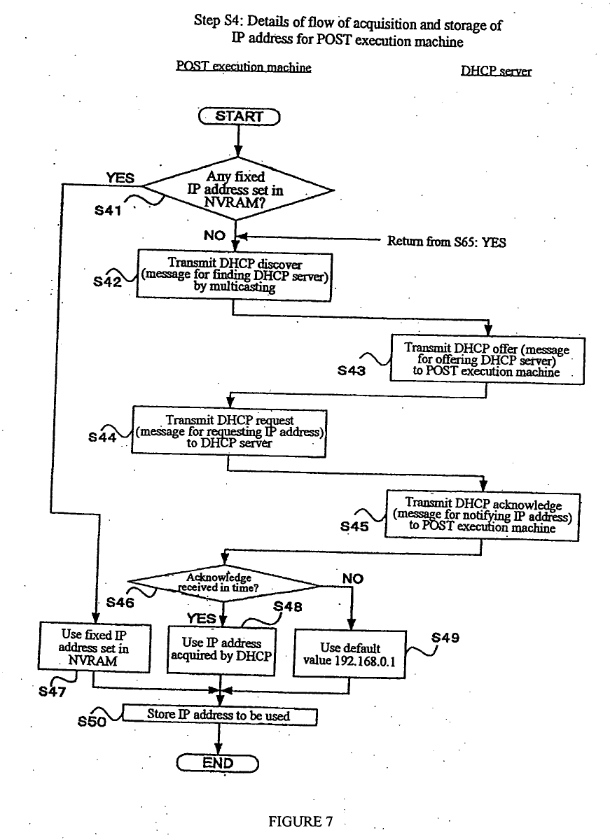

FIG. 7 is a flowchart showing further details of the operation in “S4: Acquire and store IP address of POST execution machine” shown in FIG. 5 at the time of power on for the information processing device 3.

The control section 31 of the information processing device 3 checks whether an IP address number (second address number) of the information processing device 3 is stored as a fixed value in the IP address storage section 322, which is a nonvolatile storage section (S41). If no second address number is stored as a fixed value in the nonvolatile storage section (S41: NO), the control section 31 obtains a second address number by the DHCP. If a second address number is stored as a fixed value in the nonvolatile storage section (S41: YES), it will be used (S47) and, therefore, it is stored (S50).

In the process of acquiring a second address number by the DHCP, the control section 31 of the information processing device 3 sends DHCP Discover, which is a message for finding the DHCP server 8, to the communication network 2 by multicasting (S42). When the DHCP server 8 receives DHCP Discover, it returns DHCP Offer, which is a message for offering itself as a DHCP server, to the information processing device 3 executing the POST (S43). Receiving DHCP Offer, the control section 31 of the information processing device 3 transmits DHCP Request, which is a message for requesting an IP address number, to the DHCP server 8 (S44). The DHCP server 8 returns DHCP Acknowledge, which is a message for notifying an IP address number, to the information processing device 3 executing the POST (S45).

In the information processing device 3 acquiring the IP address number (second address number), a determination is made as to whether the notice has been received in a predetermined time period, e.g., thirty seconds (S46). If the notice has been received in the predetermined time period (S46: YES), the acquired second address number will be used (S48). The acquired second address number is therefore stored (S50). If the notice has not been received in the predetermined time period (S46: NO), a default IP address number, e.g., 192.168.0.1 will be used. This second address number is therefore stored (S50).

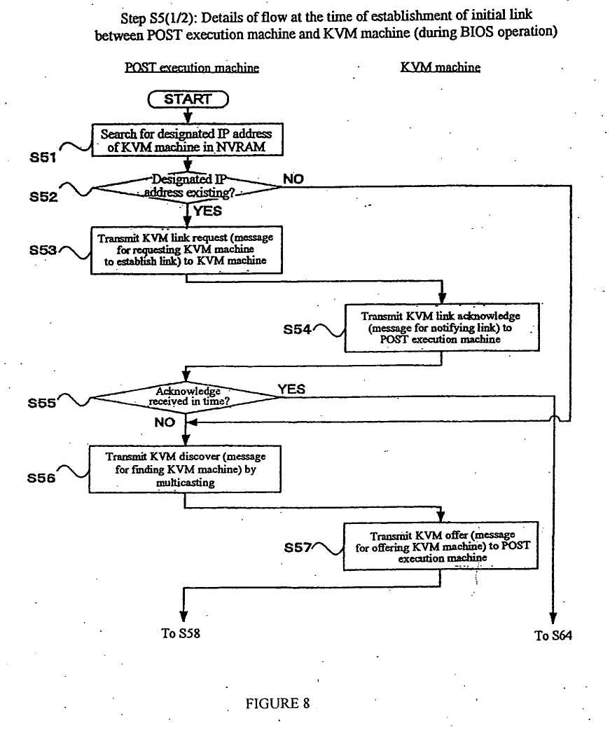

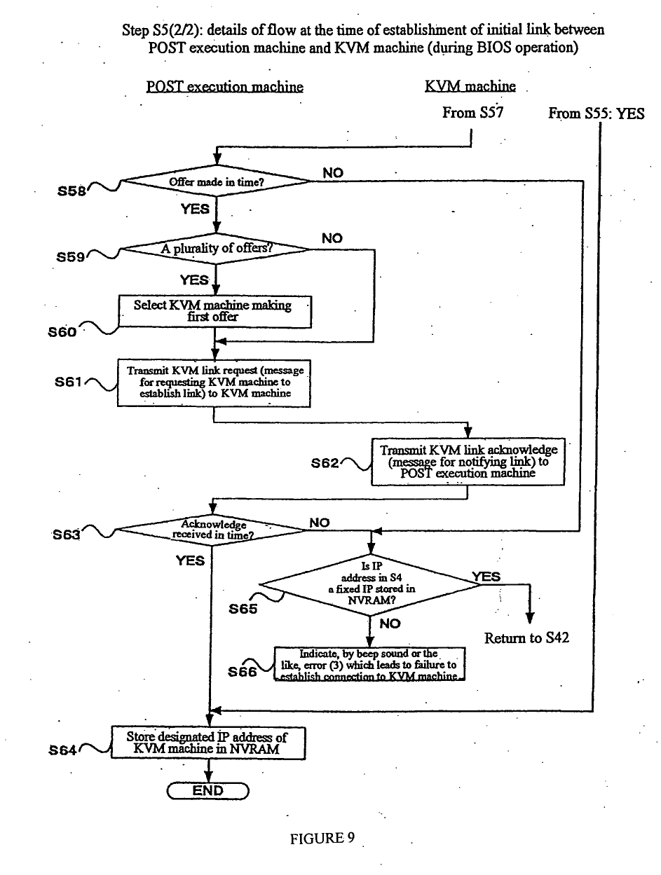

FIGS. 8 and 9 are flowcharts showing further details of the operation in “S5: Establish link between KVM machine and POST execution machine” shown in FIG. 5 at the time of power on for the information processing device 3.

In the process of establishing a link between the KVM machine and the POST execution machine, the control section 31 of the information processing device 3 searches (S51)the IP address storage section 322, which is a nonvolatile memory section (NVRAM), to check whether or not an IP address number (first address number) designated for the information processing device 1 is stored (S52). If a first address number is stored in the nonvolatile memory section (S52: YES), KVM Link Request, which is a message for requesting establishment of a link, is transmitted to the information processing device 1 (KVM machine) (S53). If no first address number is stored in the nonvolatile memory section (S52: NO), KVM Discover, which is a message for finding the information processing device 1 (KVM machine) in the communication network 2 is transmitted by multicasting (S56).

The information processing device 1 receiving KVM Link Request transmits KVM Link Acknowledge, which contains the IP address number (first address number) of the information processing device 1, and which is a message for notifying establishment of a link, to the information processing device 3 (POST execution machine) (S54).

In the information processing device 3 receiving KVM Link Acknowledge, a determination is made as to whether or not KVM Link Acknowledge has been received in a predetermined time period, e.g., twenty seconds (S55). If KVM Link Acknowledge has been received in the predetermined time period (S55: YES), the IP address number (first address number) designated by the information processing device 1 (KVM machine) is stored in the NVRAM (S64). If KVM Link Acknowledge has not been received in the predetermined time period (S55: NO), KVM Discover, which is a message for finding the information processing device 1 (KVM machine) in the communication network 2, is transmitted by multicasting (S56).

The information processing device 1 receiving KVM Discover transmits KVM Offer, which is a message for offering itself as a KVM machine, to the information processing device 3 (POST execution machine) (S57).

In the information processing device 3 receiving KVM Offer, a determination is made as to whether or not KVM Offer has been received in a predetermined time period, e.g., twenty seconds (S58). If KVM Offer has not been received in the predetermined time period (S58: NO), a determination is further made as to whether a fixed IP address number set in the NVRAM has been used as the IP address in step S4 shown in FIG. 5 (S65). If a fixed IP address number has been used (S65: YES), the process returns to step S42 shown in FIG. 7, a new IP address number is obtained for the information processing device 3 (POST execution machine) from the DHCP server, and the above-described processing is repeated. If no fixed IP address number has been used (S65: NO), an error which leads to failure to establish a connection to the information processing device 1 (KVM machine) is indicated by combination with a buzzer (beep) sound, blinking of an LED, or the like (S66).

If KVM Offer has been received in the predetermined time period (S58: YES), a determination is further made as to whether or not there are a plurality of offers (S59). If there are a plurality of offers (S59: YES), the information processing device 1 that made the offer first received is selected (S60) and KVM Link Request, which is a message for requesting an establishment of a link, is transmitted to the information processing device 1 (S61), as in step S53. If there are not a plurality of offers (S59: NO), that is, there is only one offer, KVM Link Request, which is a message for requesting establishment of a link, is transmitted to the corresponding information processing device 1 (S61).

The information processing device 1 receiving KVM Link Request transmits KVM Link Acknowledge, which contains the IP address number (first address number) of the information processing device 1, and which is a message for notifying establishment of a link, to the information processing device 3 (POST execution machine) (S62), as in step S54.

In the information processing device 3 receiving KVM Link Acknowledge, a determination is made as to whether or not KVM Link Acknowledge has been received in a predetermined time period, e.g., twenty seconds (S63), as in step S55. If KVM Link Acknowledge has been received in the predetermined time period (S63: YES), the IP address number(first address number) designated by the information processing device 1 (KVM machine) is stored in the NVRAM (S64). If KVM Link Acknowledge has not been received in the predetermined time period (S63: NO), a determination is further made as to whether a fixed IP address number set in the NVRAM has been used as the IP address in step S4 shown in FIG. 5(S65). If a fixed address number has been used (S65: YES), the process returns to step S42 shown in FIG. 7, a new IP address number is obtained for the information processing device 3 (POST execution machine) from the DHCP server, and the above-described processing is repeated. If no fixed IP address number has been used (S65: NO), an error which leads to failure to establish a connection to the information processing device 1 (KVM machine) is indicated by combination with a buzzer (beep) sound, blinking of an LED, or the like (S66).

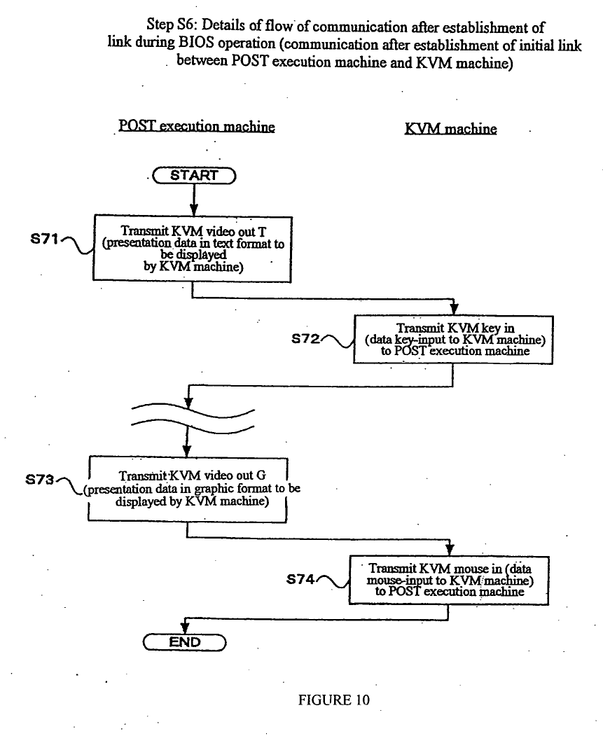

FIG. 10 is a flowchart showing further details of the operation in “S6: Communication after establishment of link during BIOS operation” shown in FIG. 5 at the time of power on for the information processing device 3. In the following description, selection as to whether transmission/reception of presentation data in a text format or transmission/reception of presentation data in a graphic format is performed between the information processing device 1 and the information processing device 3 between which a link has been established can be freely determined.

The control section 31 of information processing device 3 having a link to the information processing device 1 established transmits KVM Video Out T, which is presentation data in a text format to be displayed on the information processing device 1, to information processing device 1 on the frame-by-frame basis (S71).

The control section 11 of the information processing device 1 displays the received presentation data on a display or the like of the user output device 6, and transmits a data code of a KVM key in, which is an input made through a keyboard, a mouse or the like of the user input device 7, to the information processing device 3 (S72).

Steps S73 and S74 are performed in a case where presentation data in a graphic format is transmitted from the information processing device 3, while presentation data in a text format is transmitted from the information processing device 3 in steps S71 and S72. In other respects, steps S73 and S74 are the same as steps S71 and S72.

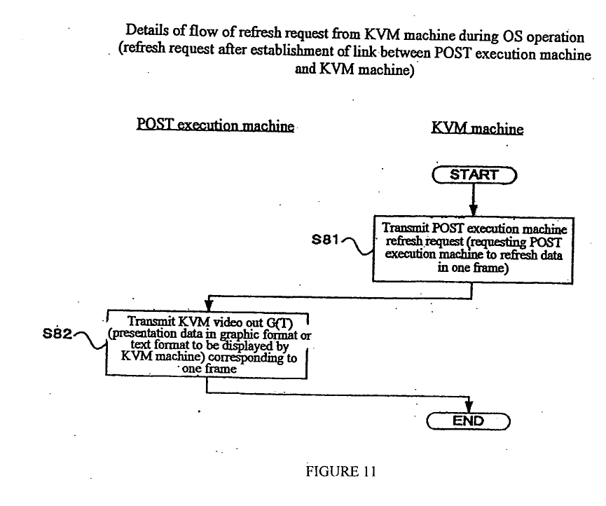

FIG. 11 is a flowchart showing the operation in the case of refreshing the display screen of the KVM machine in “S6: Communication after establishment of link during BIOS operation” shown in FIG. 5 at the time of power on for information processing device 3, or in “S12: Communication after establishment of link during OS operation”.

After the link is established during BIOS or OS operation of the information processing device 1 and the information processing device 3, the information processing device 1 (KVM machine) transmits POST Execution Machine Refresh Request, which is a request for transmission of data corresponding to one frame for refreshment of the display screen of the information processing device 1, to the information processing device 3 (POST execution machine) (S81).

The information processing device 3 receiving POST Execution Machine Refresh Request transmits the corresponding one-frame presentation data to the information processing device 1 according to the contents of the request (S82). At this time, determination as to whether presentation data in a text format or presentation data in a graphic format is transmitted from the information processing device 3 to the information processing device 1 between which a link has been established is made according to the request from the information processing device 1.

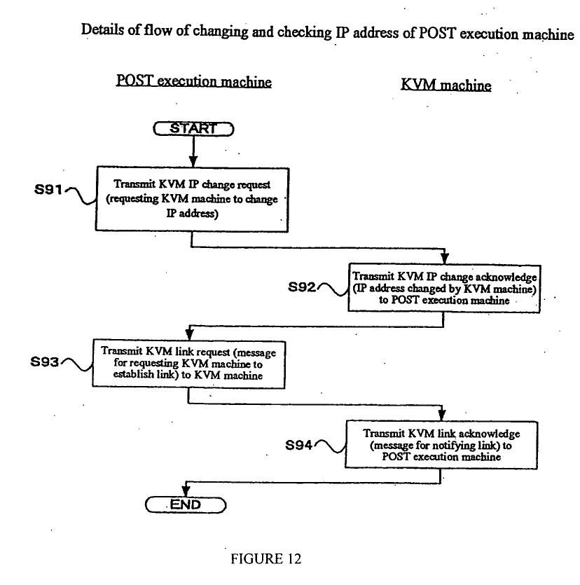

FIG. 12 is a flowchart showing the operation in the case of changing the IP address number of the KVM machine in “S6: Communication after establishment of link during BIOS operation” shown in FIG. 5 at the time of power on for the information processing device 3, or in “S12: Communication after establishment of link during OS operation”.

First, the information processing device 3 (POST execution machine) transmits KVM IP Change Request, which is a request for changing the IP address number (first address number) used for the information processing device 1, to the information processing device 1 (KVM machine) (S91).

The information processing device 1 receiving KVM IP Change Request transmits KVM IP Change Acknowledge, which is a notice including the first address number changed by processing such as DHCP processing, to the information processing device 3 (S92).

The information processing device 3 receiving KVM IP Change Acknowledge transmits KVM Link Request, which is a message for requesting establishment of a link, to the information processing device 1 (KVM machine) (S93).

The information processing device 1 receiving KVM Link Request transmits KVM Link Acknowledge, which contains the IP address number (first address number) of the information processing device 1, and which is a message for notifying establishment of a link, to the information processing device 3 (POST execution machine) (S94).

Thus, in the system of this embodiment, each information processing device does not use any special piece of equipment which is not used in ordinary cases, and a link between the information processing device 3 (4, 5) equipped with no user interface and the information processing device 1 having a user interface and connected via a communication network can be established even during the BIOS operation of the information processing device 3 (4,5) equipped with no user interface. After establishment of the link, the state of the POST can be displayed on the information processing device 1 and setup operations can be performed.

While the embodiment has been described with respect to a case where the communication network 2 is a local area network (LAN), the present invention is not limited to such a case. For example, the present invention can also be applied in a case where a point-to-point connection is made via the Internet or by a crossover cable.

1. An information processing system including at least one first communication-enabled information processing device equipped with a user interface and at least one second communication-enabled information processing device equipped with no user interface are connected to each other through a communication network, said system being characterized in that:
said first communication-enabled information processing device has at least a storage section storing a driver program for a user input/output device, and a storage section storing a program for emulating said second communication-enabled information processing device through the user interface, said user input/output device being connected to said first communication-enabled information processing device; and
said second communication-enabled information processing device has a BIOS (Basic Input Output System) storage section which stores at least a check program for checking the operation of a communication control section, an address acquisition program for acquiring a second address number of said second communication-enabled information processing device in the communication network, and a program for establishing a link with said first communication-enabled information processing device, and an OS (Operating System) storage section which stores at least a program for inheriting said second address number and changing said second address number if needed, and a program for inheriting the link with said first communication-enabled information processing device.

2. The information processing system according to claim 1, wherein said storage section storing the emulation program has a link request reply program by which said first communication-enabled information processing device establishes a link and notifies said second communication-enabled information processing device when said first communication-enabled information processing device receives a link request message sent from said second communication-enabled information processing device during BIOS operation.

3. The information processing system according to claim 1, wherein said storage section storing the emulation program has an offer program by which said first communication-enabled information processing device sends a link offering message to said second communication-enabled information processing device when said first communication-enabled information processing device receives a message sent from said second communication-enabled information processing device during BIOS operation for locating a first communication-enabled information processing device as a link destination.

4. The information processing system according to claim 1, wherein said storage section storing the emulation program has an autopause and autosetup program having the functions of automatically pausing a POST output message and automatically entering a setup screen when said second communication-enabled information processing device is executing a POST (Power-On Self Test) during BIOS operation.

5. The information processing system according to claim 1, wherein said storage section storing the emulation program has a screen refresh request program by which said first communication-enabled information processing device requests said second communication-enabled information processing device to transmit data corresponding to one frame for refreshment of said display screen of said first communication-enabled information processing device.

6. The information processing system according to claim 1, wherein said storage section storing the emulation program has a program by which said first communication-enabled information processing device notifies said second communication-enabled information processing device of a changed first address number and reestablishes a link at a request from said second communication-enabled information processing device when said first communication-enabled information processing device receives from said second communication-enabled information processing device a request message for changing the current first address number of said first communication-enabled information processing device.

7. The information processing system according to claim 1, wherein said BIOS storage section has a program for transmitting presentation data in a text format from said second communication-enabled information processing device to said first communication-enabled information processing device.

8. The information processing system according to claim 1, wherein said BIOS storage section has a program for transmitting presentation data in a graphic format from said second communication-enabled information processing device to said first communication-enabled information processing device.

9. The information processing system according to claim 1, wherein said BIOS storage section has a program for checking at least existence of said second address number stored in nonvolatile storage.

10. The information processing system according to claim 1, wherein, in said BIOS storage section, either a program for checking the operation of the user interface is not provided or it is set in a suspended state.

11. A method to implement a BIOS operation stage in a communication-enabled information processing device equipped with no user interface comprising:
(1) initiating power and starting a POST (Power On Self Test);
(2) checking the operation of a communication control section;
(3) acquiring a second address number of said communication-enabled information processing device in a communication network;
(4) establishing a link between a first and said second communication-enabled information processing devices;
(5) sending presentation data to said first communication-enabled information processing device;
(6) executing contents received from said first communication-enabled information processing device;
(7) terminating the POST; and
(8) booting an OS (Operating System).

12. The method according to claim 11 further including:
(9) inheriting the link established in said BIOS operation stage and the second address number;
(10) transmitting presentation data to said first communication-enabled information processing device; and
(11) executing contents received from said first communication-enabled information processing device.

13. The method according to claim 11, wherein acquiring a second address number includes checking whether said second address number (3) is stored as a fixed value in a nonvolatile storage section.

14. The method according to claim 13, wherein acquiring a second address number (3) includes acquiring said second address number by a DHCP (Dynamic Host Configuration Protocol) if said second address number is not stored as a fixed value in the nonvolatile storage section.

15. The method according to claim 13, wherein acquiring a second address number (3) includes using a default second address number if said second address number cannot be obtained by the DHCP.

16. The method according to claim 11, wherein establishing a link (4) includes checking whether a first address number of the first communication-enabled information processing device is stored in the nonvolatile storage section.

17. The method according to claim 16, wherein establishing a link (4) includes requesting said first communication-enabled information processing device to establish a link when said first address number is stored in the nonvolatile storage section.

18. The method according to claim 17, wherein establishing a link (4) includes storing a first address number in the nonvolatile storage section if a reply including said first address number is received in a predetermined time period from said first communication-enabled information processing device in response to the link establishment request.

19. The method according to claim 17, wherein establishing a link (4) includes transmitting a message for finding said first communication-enabled information processing device to the communication network by multicasting if no reply including the first address number is received in the predetermined time period from said first communication-enabled information processing device in response to the link establishment request.

20. The method according to claim 16, wherein establishing a link (4) includes transmitting a message for finding said first communication-enabled information processing device to the communication network by multicasting if said first address number is not stored in the nonvolatile storage section.

21. The method according to claim 19, wherein said establishing a link (4) includes checking whether or not there are a plurality of offers when an offer from said first communication-enabled information processing device is received in the predetermined time period as a result of multicasting the message for finding said first communication-enabled information processing device to the communication network.

22. The method according to claim 21, wherein said establishing a link (4) includes selecting said first communication-enabled information processing device that transmitted the offer first received in a case where there are a plurality of offers as a result of multicasting the message for finding said first communication-enabled information processing device to the communication network.

23. The method according to claim 22, wherein establishing a link (4) includes requesting said first communication-enabled information processing device that transmitted the offer first received to establish the link.

24. The method according to claim 21, wherein establishing a link (4) includes requesting said first communication-enabled information processing device that transmitted the received offer in a case where there are not a plurality of offers as a result of multicasting the message for finding said first communication-enabled information processing device to the communication network.

25. The method according to claim 23, wherein said establishing a link (4) includes storing the first address number in the nonvolatile storage section if a reply including said first address number is received in the predetermined time period from said first communication-enabled information processing device in response to the link establishment request.

26. The method according to claim 23, wherein said establishing a link (4) includes checking whether or not said second address number is a fixed value stored in the nonvolatile storage section if no reply including the first address number is received in the predetermined time period from said first communication-enabled information processing device in response to the link establishment request.

27. The method according to claim 26, wherein said acquiring a second address number (3) is repeated if in said establishing a link (4), said second address number is a fixed value stored in the nonvolatile storage section.

28. The method according to claim 11, further comprising after establishment of a link between the first and said second communication-enabled information processing devices during BIOS operation or OS operation:
(12) in said first communication-enabled information processing device, transmitting a request to said second communication-enabled information processing device for transmission of data corresponding to one frame for refreshment of the display screen of said first communication-enabled information processing device; and
(13) in said second communication-enabled information processing device, transmitting presentation data corresponding to one frame to said first communication-enabled information processing device when the request for transmission of data corresponding to one frame is received.

29. The method according to claim 11, further comprising the steps of:
(14) in said second communication-enabled information processing device, transmitting a request to said first communication-enabled information processing device for changing the first address number used in said first communication-enabled information processing device;
(15) in said first communication-enabled information processing device, transmitting a changed first address number when the request for changing said first address number is received;
(16) in said second communication-enabled information processing device, requesting said first communication-enabled information processing device to establish a link between said first and second communication-enabled information processing devices; and
(17) in said first communication-enabled information processing device, transmitting a notice of establishment of a link to said second communication-enabled information processing device when the request for establishment of a link is received.

30. A system for use in a network including at least one communication-enabled information processing device having no user interface comprising:
a communication enabled information processing device equipped with a user interface;
I/O devices operatively coupled to said user interface; and
a storage section, in said user equipped processing device, storing a driver program for a user input/output device, and a storage section storing a program for emulating said second communication-enabled information processing device through the user interface.
